(19) United States
(12) Patent Application Publication
(10) Pub. No.: US 2016/0186530 A1
(43) Pub. Date: Jun. 30, 2016

(54) METHOD FOR IN-WELLBORE WELDING

(71) Applicant: Husky Oil Operations Limited, Calgary (CA)

(72) Inventors: Lawrence J. Frederick, Calgary (CA); Shaun Zimmer, Calgary (CA); Warren Kozak, Calgary (CA)

(21) Appl. No.: 14/983,795

(22) Filed: Dec. 30, 2015

Related U.S. Application Data
(60) Provisional application No. 62/098,599, filed on Dec. 31, 2014.

(51) Int. Cl. E21B 41/00; E21B 47/09; E21B 7/06; B23K 31/02; E21B 29/06

(52) U.S. Cl. CPC E21B 41/00; B23K 31/027; E21B 29/06; E21B 7/061; E21B 47/09

(57) ABSTRACT

A method for welding within a tubular member situated in a hydrocarbon wellbore. Downhole junctions for branch wellbores can be welded, casing windows for sidetrack drilling can be prepared, and casing repairs can be undertaken.

### CROSS-REFERENCE TO RELATED APPLICATION

This application claims the benefit of and priority to U.S. Provisional Patent Application Ser. No. 62/098,599, filed Dec. 31, 2014, entitled “Method for In-Wellbore Welding,” the contents of which are incorporated herein in its entirety for all purposes.

### FIELD OF THE INVENTION

The present invention relates to hydrocarbon recovery equipment, and particularly to methods for creating multileg branches and repairing downhole casing sections.

### BACKGROUND OF THE INVENTION

It is known in the art of hydrocarbon production from subsurface formations to drill a wellbore from the surface to a formation of interest, the formation housing the target hydrocarbon.

In order to enable an optimized recovery program, the use of multileg laterals or branches has been developed. Multileg laterals are wells that are drilled from the main well, branching off in a desired direction or angle and/or to a desired depth, thus allowing greater access to the subsurface resource at reduced cost when compared to conventional multiple-well arrangements.

However, the creation of multileg laterals can present challenges to the operator, and some junction technology is highly complex and expensive to implement.

Also, it is known that casing in main wellbores and lateral wellbores can become damaged and require repair. However, repairs in a downhole environment can be very difficult to undertake given conventional repair methods.

### SUMMARY OF THE INVENTION

The present invention therefore seeks to provide methods to use in-wellbore welding to create junctions for multileg laterals, and to repair some types of casing damage in the downhole environment. In addition, in-wellbore welding can be employed to cut windows in downhole casing to allow for sidetrack drilling.

Welding equipment would be reduced in size as necessary to fit into the target casing or pipeline and to have the required range of movement for the specific application.

According to a first broad aspect of the present invention, there is provided a method for creating a junction for a branch wellbore, the method comprising the steps of:

drilling a main wellbore and lining the main wellbore with a first tubular member;
cutting an aperture in the first tubular member;
drilling a branch wellbore through the aperture and lining the branch wellbore with a second tubular member, the second tubular member extending back at a first end to the main wellbore;
where necessary to align the first end and the aperture, removing a portion of the second tubular member extending back to the main wellbore at the first end so that the first end of the second tubular member is adjacent the aperture in the first tubular member at a welding target area;
running sensor means, control means and welding equipment down the main wellbore;
using the sensor means to locate the welding target area;
using the control means to position the welding equipment over the welding target area; and
using the control means to direct the welding equipment to weld a bead of welding material across the welding target area to provide a seal between the aperture and the first end.

While reference is made to a “main wellbore” and a “branch wellbore”, it will be clear that this method can apply to a secondary branch extending off of a branch wellbore, such that the “main wellbore” is itself a branch wellbore of a primary wellbore and the “branch wellbore” then refers to a wellbore drilled off of this “main” branch wellbore.

The tubular member may be a length of casing, liner or tubing. In some exemplary embodiments of the first aspect, the step of removing the portion of the second tubular member comprises milling off the portion of the second tubular member. The first and second tubular members are preferably composed primarily of steel, but they can be composed of other weldable materials, such as for non-limiting examples aluminum or iron. The seal may be either a sand seal or a hydraulic seal.

In some embodiments, a drill bit deflected by a whipstock is used for cutting the aperture and for subsequently drilling the branch wellbore, although other cutting techniques such as jetting could be employed, or the aperture could be pre-cut at surface.

The sensor means may comprise a downhole camera. The welding equipment is preferably powered by an electrical line from surface, although other power means such a downhole battery could be employed. The sensor means, the control means and the welding equipment are preferably a unitary assembly run down the main wellbore together.

According to a second broad aspect of the present invention, there is provided a method for creating a junction for each of a plurality of branch wellbores, the method comprising the steps of:

drilling a main wellbore and lining the main wellbore with a first tubular member;
cutting a plurality of apertures in the first tubular member;
drilling a branch wellbore through each of the plurality of apertures and lining each branch wellbore with a second tubular member, each second tubular member extending back at a first end to the main wellbore;
where necessary to align each first end and the respective aperture, removing a portion of each second tubular member extending back to the main wellbore at the first end of each second tubular member so that the first end of each second tubular member is adjacent a respective aperture of the plurality of apertures in the first tubular member at a respective welding target area;
running sensor means, control means and welding equipment down the main wellbore;
using the sensor means to locate each of the welding target areas;
using the control means to position the welding equipment over each of the welding target areas; and
using the control means to direct the welding equipment to weld a bead of welding material across each of the welding target areas to provide a seal between each of the plurality of second tubular members and the respective apertures.

As indicated above, while reference is made to a “main wellbore” and a “branch wellbore”, it will be clear that this method can apply to a secondary branch extending off of a branch wellbore, such that the “main wellbore” is itself a branch wellbore of a primary wellbore and the “branch wellbore” then refers to a wellbore drilled off of this “main” branch wellbore.

Again, the tubular member may be a length of casing, liner or tubing. In some exemplary embodiments of the second aspect, the step of removing the portion of each second tubular member comprises milling off the portion of each second tubular member. The first and second tubular members are preferably composed primarily of steel, but they can be composed of other weldable materials, such as for non-limiting examples aluminum or iron. The seal may be either a sand seal or a hydraulic seal.

In some embodiments, a drill bit deflected by a whipstock is used for cutting the apertures and for subsequently drilling the branch wellbores, although other cutting techniques such as jetting could be employed, or the aperture could be pre-cut at surface.

The sensor means may comprise a downhole camera. The welding equipment is preferably powered by an electrical line from surface, although other power means such a downhole battery could be employed. The sensor means, the control means and the welding equipment are preferably a unitary assembly run down the main wellbore together.

In some preferred embodiments of this aspect of the present invention, a first aperture is formed at a target area furthest downhole and the branch wellbore is drilled through that first aperture and lined, and then welding is completed. A second aperture is subsequently formed uphole of the first aperture, with drilling, lining and welding in sequence. Subsequent branch wellbore formation and welding is completed in a similar fashion, moving uphole each time.

According to a third broad aspect of the present invention, there is provided a method for in-wellbore repair of a tubular member in a wellbore, the method comprising the steps of:

identifying presence of an area of damage on the tubular member;
running sensor means, control means and welding equipment down the main wellbore;
using the sensor means to determine location of the area of damage;
using the control means to position the welding equipment over the location of the area of damage; and
using the control means to direct the welding equipment to weld a bead of welding material across the area of damage.

In some exemplary embodiments of the third aspect, the step of identifying the area of damage on the tubular member comprises the use of identification means selected from the group consisting of calipers, a casing log, a flow detection device and a downhole camera.

The sensor means may comprise a downhole camera, although other sensor types such as acoustic, thermal, gamma, density or resistivity may be employed where appropriate. The welding equipment is preferably powered by an electrical line from surface, although other power means such a downhole battery could be employed. The sensor means, the control means and the welding equipment are preferably a unitary assembly run down the main wellbore together. The sensor means, the control means and the welding equipment may be deployed using any one of a number of conventional technologies known to the skilled person, such as but not limited to wireline, coil tubing, or drillpipe.

Advantageously, methods according to the present invention could have application to most formations and oil and gas reservoirs, and to main and branch wellbores of varying orientations.

A detailed description of exemplary embodiments of the present invention is given in the following. It is to be understood, however, that the invention is not to be construed as being limited to these embodiments.

### BRIEF DESCRIPTION OF THE DRAWINGS

In the accompanying drawings, which illustrates exemplary embodiments of the present invention:

FIG. 1 is a flowchart illustrating an exemplary method for creating a junction for a branch wellbore;

FIG. 2 is a flowchart illustrating an exemplary method for creating a junction for each of a plurality of branch wellbores; and

FIG. 3 is a flowchart illustrating an exemplary method for in-wellbore repair of a tubular member in a wellbore.

Exemplary embodiments of the present invention will now be described with reference to the accompanying drawings.

### DETAILED DESCRIPTION OF EXEMPLARY EMBODIMENTS

Throughout the following description specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise forms of any exemplary embodiment. Accordingly, the description and drawings are to be regarded in an illustrative, rather than a restrictive, sense.

The present invention is directed to the use of in-wellbore welding to achieve certain desirable goals in the downhole environment. In-wellbore welding is known in the art. For example, U.S. Pat. No. 6,371,211 to Heijnen et al. discloses a method of creating a weld in a wellbore, comprising selecting and sealing a volume portion of the wellbore, and providing pressure control means for controlling (reducing) the fluid pressure in said selected volume portion to allow the welding activity. However, it has been found that in-wellbore welding may have numerous useful applications.

As will be clear to those skilled in the art, the welding equipment itself would need to be small enough to fit within the casing or pipeline being welded, and would need to have the required range of motion to engage in the particular welding activity. Also, the welding equipment would need to be capable of functioning in the particular downhole environment, which may require some sealing and/or pressure control mechanism, including displacement of fluid from the sealed section, all of which is known in the art. In addition, the welding equipment would be operating downhole, and thus must be capable of remote operation from surface, and as such would likely also require some form of sensing technology to enable remote operation.

Some exemplary methods according to the present invention could represent significant cost savings over conventional downhole junction creation techniques, and could also be much simpler to operate and implement.

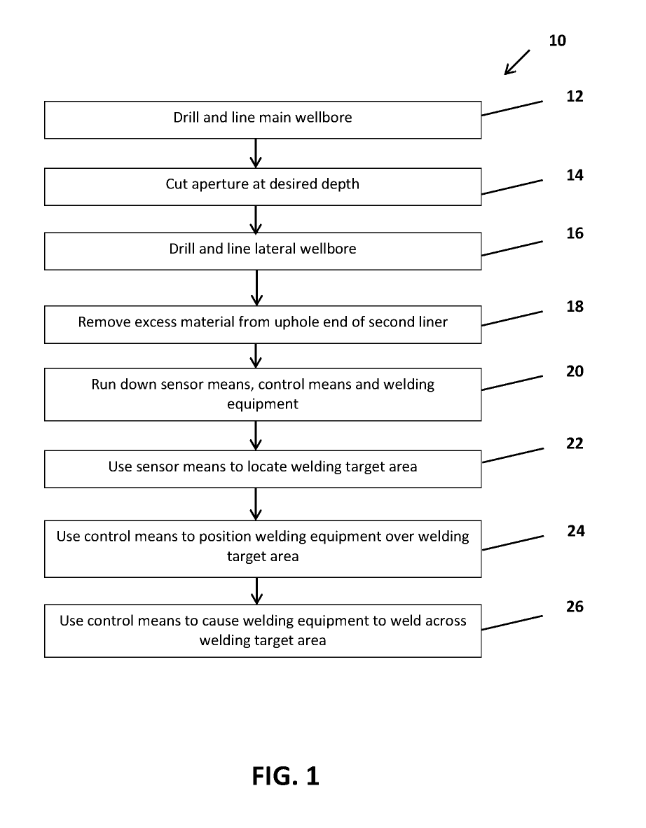

Turning now to FIG. 1, a first exemplary method 10 according to the present invention is illustrated. In this method 10, a main wellbore would be drilled and lined in a conventional manner at step 12; in this exemplary embodiment the lining is conducted with a steel liner, although the exemplary method could be used with other tubular members such as casing or tubing, and with other weldable materials. To enable the creation of a branch junction, which in this exemplary method is a lateral junction, the next step is to select a depth at which the lateral junction will be created, and then an aperture can be cut in the liner at the desired depth at step 14. While there are many conventional means known to the skilled person for cutting an aperture in a steel liner, in this exemplary embodiment this is achieved by running a drill string down the lined wellbore and, using a whipstock to deflect the drill bit, driving the drill bit into the liner to form the aperture.

As a drill string is already in place with a drill bit at the aperture, drilling a lateral wellbore through the aperture at step 16 can be simply achieved by continued use of the drill string. Alternatively, the means for creating the aperture can be removed from the wellbore and a drill string run down the wellbore to drill the lateral wellbore.

Once drilled at step 16, the lateral wellbore would also be lined with a conventional steel liner. While the second liner may be prepared so as to align with the aperture for subsequent welding, this second liner may extend back into the main wellbore. To remove this undesirable material at step 18, conventional means can be run down the main wellbore, such as a mill to mill off the excess second liner. In this way, the milled end of the second liner is aligned with the aperture in the first liner and the two liners are ready for welding together to form the desired junction.

In this exemplary embodiment, sensor means, control means and welding equipment are formed as a unitary assembly and run down the main wellbore at step 20, powered by an electrical line from surface. The sensor means—which can for one non-limiting example be a downhole camera—can thus be used at step 22 to locate the welding target area, namely the aligned liner edges.

Once the welding target area has been located by the sensor means, the control means can then be used at step 24 to position the welding equipment over the welding target area. There are many available control means that would be known to those skilled in the art. With the welding equipment positioned over the welding target area, the control means are then used at step 26 to direct the welding equipment to weld a bead of welding material across the welding target area to provide a seal between the aperture and the first end. The seal type would be determined with reference to the operational needs, but it could be a sand seal or a hydraulic seal, or both. The particular type of weld can be determined by the skilled person, including the need for any gap casing piece that might be required.

The above exemplary method would have numerous advantages over conventional lateral well creation techniques, as will be clear to those skilled in the art. The person skilled in the art would also be able to determine any temperature or pressure limitations inherent in using the present invention in a particular downhole environment, as well as any post-welding inspection steps that should be undertaken. The skilled person would also be able to determine if a gap sub may be a desirable tool to use in preparing the materials for welding or engaging in the welding itself.

As will be clear to those skilled in the art, a bead of weld is typically present after a welding process, and this bead could make it difficult to re-enter the new branch wellbore. It is therefore desirable that methods according to the present invention take into account an acceptable internal projection of the weld, for example a 1 mm limitation.

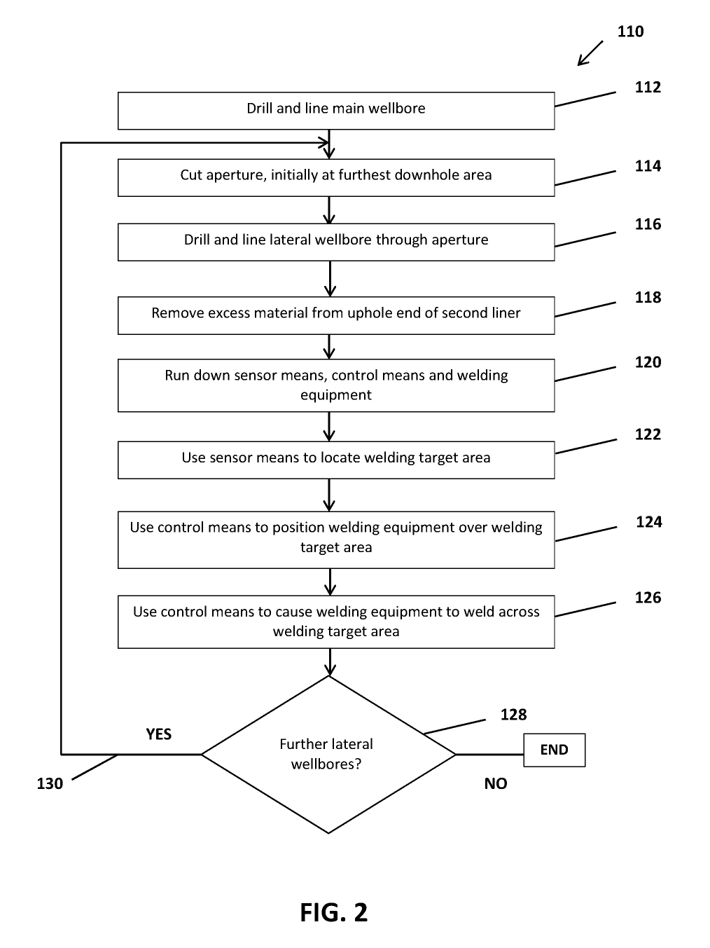

While the above exemplary method is set forth with reference to only a single aperture and lateral wellbore, it will be clear to those skilled in the art that multiple apertures could be cut into the main liner to enable the drilling of multiple lateral wellbores, and the lateral liners can be welded to the corresponding apertures. Turning now to FIG. 2, a second exemplary method 110 is illustrated. Similar to the method 10 described above, a main wellbore would be drilled and lined in a conventional manner at step 112. A first aperture is then cut in the liner at step 114, which will occur at the furthest downhole location desired for a lateral wellbore. A first lateral wellbore is drilled through this first aperture and lined, at step 116, and excess material is removed from the uphole end of the lateral wellbore liner at step 118.

Sensor means, control means and welding equipment are run down at step 120, and the sensor means are used at step 122 to locate the welding target area. Having located the welding target area, the control means can then be used at step 124 to position the welding equipment over the welding target area. At step 126, the control means are then used to cause the welding equipment to weld a bead across the welding target area to create the desired seal.

At this point a decision stage is reached at step 128. If further lateral wellbores are desired at locations uphole of the first lateral wellbore, the method 110 loops back at step 130 to step 114 where a new aperture is formed in the main wellbore uphole of the previous aperture. Steps 116 through 126 follow in sequence, again returning to step 128 and the decision as to whether or not to form additional lateral wellbores. Once the desired number of lateral wellbores have been formed, the method 110 is concluded.

In this manner, a plurality of lateral wellbores are formed, starting at the furthest downhole target area and progressing in an uphole direction until all desired lateral wellbores have been completed.

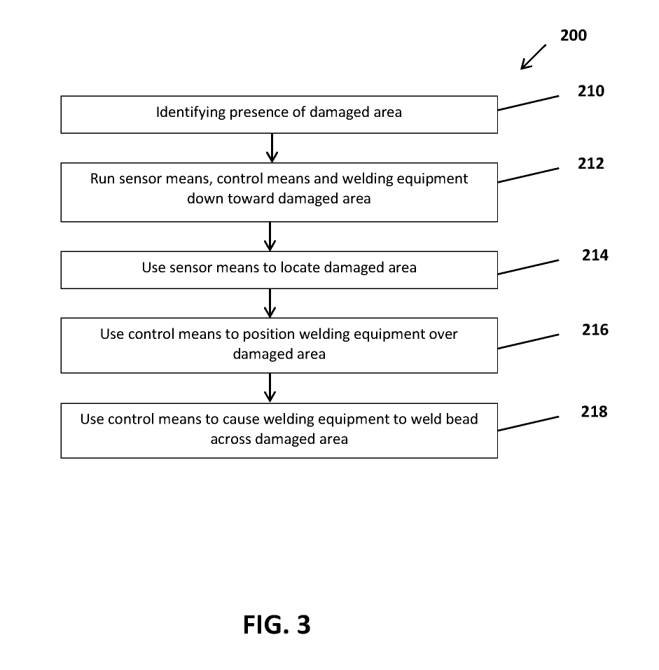

As indicated above, it is also known that downhole casing can become damaged, and repair can be difficult and costly. Using in-wellbore welding in accordance with the present invention may afford a simpler and more cost-effective solution. According to a further exemplary embodiment of the present invention illustrated in FIG. 3, then, a method 200 for in-wellbore casing repair would comprise first identifying the presence of a damaged area on the casing member at step 210. Such an identification could be achieved by a number of known methods in the art, such as for example calipers, a casing log, a flow detection device or a downhole camera. The identification means may then be run out of the wellbore to allow for the welding step, or alternatively the identification means could be part of the welding assembly itself and thus remain in-hole for the welding step.

Welding equipment would be run down the hole at step 212, and in the exemplary embodiment would comprise sensor means (such as for example a downhole camera) for locating the damaged area that has been identified, control means for directing the welding equipment, and the welding equipment itself for welding the damaged area.

After the sensor means has determined the location of the damaged area at step 214, the operator would use the control means at step 216 to position the welding equipment over the location where the damaged area has been sensed. The control means are then subsequently used at step 218 to direct the welding equipment, powered by an electrical line from surface, to weld a bead of welding material across the damaged area to repair it.

Embodiments of the present invention could also be employed to repair casing leaks or to cut windows in the casing in preparation for sidetrack drilling.

As will be clear from the above, those skilled in the art would be readily able to determine obvious variants capable of providing the described functionality, and all such variants and functional equivalents are intended to fall within the scope of the present invention.

Specific examples have been described herein for purposes of illustration. These are only examples. The technology provided herein can be applied to contexts other than the exemplary contexts described above. Many alterations, modifications, additions, omissions and permutations are possible within the practice of this invention. This invention includes variations on described embodiments that would be apparent to the skilled person, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

The foregoing is considered as illustrative only of the principles of the invention. The scope of the claims should not be limited by the exemplary embodiments set forth in the foregoing, but should be given the broadest interpretation consistent with the specification as a whole.

What is claimed is:

1. A method for creating a junction for a branch wellbore, the method comprising the steps of:
drilling a main wellbore and lining the main wellbore with a first tubular member;
cutting an aperture in the first tubular member;
drilling a branch wellbore through the aperture and lining the branch wellbore with a second tubular member, the second tubular member extending back into the main wellbore;
removing a portion of the second tubular member extending back into the main wellbore at a first end so that the first end of the second tubular member is adjacent the aperture in the first tubular member at a welding target area;
running sensor means, control means and welding equipment down the main wellbore;
using the sensor means to locate the welding target area;
using the control means to position the welding equipment over the welding target area; and
using the control means to direct the welding equipment to weld a bead of welding material across the welding target area to provide a seal between the aperture and the first end.

2. The method of claim 1 wherein the step of removing the portion of the second tubular member comprises milling off the portion of the second tubular member.

3. The method of claim 1 wherein the seal is a sand seal.

4. The method of claim 1 wherein the seal is a hydraulic seal.

5. The method of claim 1 wherein the first tubular member is composed primarily of steel.

6. The method of claim 1 wherein the second tubular member is composed primarily of steel.

7. The method of claim 1 wherein a drill bit deflected by a whipstock is used for cutting the aperture and for subsequently drilling the branch wellbore.

8. The method of claim 1 wherein the sensor means comprise a downhole camera.

9. The method of claim 1 wherein the welding equipment is powered by an electrical line from surface.

10. The method of claim 1 wherein the sensor means, the control means and the welding equipment are a unitary assembly run down the main wellbore together.

11. A method for creating a junction for each of a plurality of branch wellbores, the method comprising the steps of:
drilling a main wellbore and lining the main wellbore with a first tubular member;
cutting a plurality of apertures in the first tubular member;
drilling a branch wellbore through each of the plurality of apertures and lining each branch wellbore with a second tubular member, each second tubular member extending back into the main wellbore;
removing a portion of each second tubular member extending back into the main wellbore at a first end of each second tubular member so that the first end of each second tubular member is adjacent a respective aperture of the plurality of apertures in the first tubular member at a respective welding target area;
running sensor means, control means and welding equipment down the main wellbore;
using the sensor means to locate each of the welding target areas;
using the control means to position the welding equipment over each of the welding target areas; and
using the control means to direct the welding equipment to weld a bead of welding material across each of the welding target areas to provide a seal between each of the plurality of second tubular members and the respective apertures.

12. The method of claim 11 wherein the step of removing the portion of each second tubular member comprises milling off the portion of each second tubular member.

13. The method of claim 11 wherein each seal is a sand seal.

14. The method of claim 11 wherein each seal is a hydraulic seal.

15. The method of claim 11 wherein each first tubular member is composed primarily of steel.

16. The method of claim 11 wherein each second tubular member is composed primarily of steel.

17. The method of claim 11 wherein a drill bit deflected by a whipstock is used for cutting the apertures and for subsequently drilling the branch wellbores.

18. The method of claim 11 wherein the sensor means comprise a downhole camera.

19. The method of claim 11 wherein the welding equipment is powered by an electrical line from surface.

20. The method of claim 11 wherein the sensor means, the control means and the welding equipment are a unitary assembly run down the main wellbore together.

21. A method for in-wellbore repair of a tubular member in a wellbore, the method comprising the steps of:
identifying presence of an area of damage on the tubular member;
running sensor means, control means and welding equipment down the main wellbore;
using the sensor means to determine location of the area of damage;
using the control means to position the welding equipment over the location of the area of damage; and
using the control means to direct the welding equipment to weld a bead of welding material across the area of damage.

22. The method of claim 21 wherein the step of identifying the area of damage on the tubular member comprises the use of identification means selected from the group consisting of calipers, a casing log, a flow detection device and a downhole camera.

23. The method of claim 21 wherein the sensor means comprise a downhole camera.

24. The method of claim 21 wherein the welding equipment is powered by an electrical line from surface.

25. The method of claim 21 wherein the sensor means, the control means and the welding equipment are a unitary assembly run down the main wellbore together.
